(19) United States
(12) Patent Application Publication
(10) Pub. No.: US 2011/0081472 A1
(43) Pub. Date: Apr. 7, 2011

(54) METHOD OF PREPARING A FOOD PRODUCT

(76) Inventors: Rodney Anderson, Coralville, IA (US); Joe Kopke, Coralville, IA (US); Travis Silvey, Coralville, IA (US)

(21) Appl. No.: 12/750,996

(22) Filed: Mar. 31, 2010

Related U.S. Application Data
(60) Provisional application No. 61/164,999, filed on Mar. 31, 2009.

(51) Int. Cl. A47J 43/28; A21D 13/00

(52) U.S. Cl. 426/560; 426/497

(57) ABSTRACT

The present invention includes a method for constructing a folded food product such as a burrito. On the premises of a restaurant, a dough ball flattened between heated platens to make a wrapper, e.g. a tortilla. The tortilla is cooked and placed onto a carrier. The carrier is advanced down the line and one or more ingredients are placed on the tortilla. The ingredients on the tortilla are mixed together with the help of a spatula. The preparer may temporarily raise an edge of the tortilla to help contain the ingredients as they are mixed. The burrito is finished off by folding and rolling the tortilla around the commingled ingredients.

### PRIORITY CLAIM

This application claims priority to U.S. Provisional Application 61/164,999 filed on Mar. 31, 2009.

### FIELD OF THE INVENTION

The invention relates to preparing a folded food product and more particularly to a folded food product with consistent taste and texture.

### BACKGROUND OF THE INVENTION

While burritos and other wrapper based foods are well known, there is always a need for a better product; especially in the fast food restaurant business. The competitive landscape initially put focus on speed of delivering the product into the customers' hands. As competition has increase, fast food operators have looked to increased quality of ingredients and better flavor to distinguish themselves in the marketplace.

Flavor is not just about taste; texture is just as important to the customer experience. Traditionally, the problem that most people have when they bite into a burrito is that they get a mouthful of rice or a mouthful of beans, but no combination of ingredients. This is result of the ‘piling’ technique of constructing burritos; namely, a pile of rice is placed on the tortilla, followed by a pile of beans, etc. The rolling of the burrito does little to mix the ingredients.

Mixing ingredients is not, however, an easy task. Mixing must be accomplished with no appreciable decrease in the speed of serving the customer. It must be done with no significant increase in food waste nor any significant increase in clean up. Problems in the any of these areas reduces the cost effectiveness of the preparation technique and thus the profitability of the restaurant; and in a business with slim margins and high competition, reduced cost effectiveness in any area cannot be tolerated.

Pre-mixing the ingredients before placing on the tortilla is not suitable solution because it turns out to be not cost effective. For example, mixing the ingredients in bowl and then placing them on the tortilla is slow and interrupts the flow of the cook line. It also results in significant amounts of wasted food and creates a significant amount of messy dishes that required cleaning Thus pre-mixing was not a suitable solution.

The present invention overcomes one or more of these problems.

### SUMMARY OF THE INVENTION

The present invention includes a method for constructing a folded food product such as a burrito. On the premises of a restaurant, a dough ball flattened between heated platens to make a wrapper, e.g. a tortilla. The tortilla is cooked and placed onto a carrier. The carrier is advanced down the cook line and one or more ingredients are placed on the tortilla. The ingredients on the tortilla are mixed together with the help of a spatula. The preparer may temporarily raise an edge of the tortilla to help contain the ingredients as they are mixed. The burrito is finished off by folding and rolling the tortilla around the commingled ingredients.

### BRIEF DESCRIPTION OF THE DRAWINGS

FIG. 1 shows a perspective view of a spatula;

FIG. 2 shows a front view of a spatula; and

FIG. 3 shows a rear view of a spatula.

### DETAILED DESCRIPTION

The present invention includes methods for making a folded food product, e.g. a burrito in a restaurant. The method may include making a food wrapper, e.g. tortilla, on the premises of the restaurant. While tortillas may be purchased in bulk, tortillas made on onsite are preferred because they are guaranteed fresh. Restaurant should be considered to include any operation that prepares food for a customer and includes take out and eat-in restaurants as well as places that delivery. Likewise, mobile food carts that are in temporary locations are also contemplated. Tortillas are preferably made in front of the customer; this gives the customer confidence that the product is fresh and also reinforces the idea that the burrito is made to order. The tortilla is made by flattening a dough ball between heated platens. This provides initial shaping of the tortilla to a generally circular shape and an initial warming/cooking to make the tortilla easier to handle. After flattening, the tortilla is cooked to its final consistency. Typically, this is done on a griddle separate from the platens because the platens do not have sufficient heat capacity to fully cook the tortilla; other cooking methods may also be used including leaving the tortilla on the platens. Other food wrappers besides tortillas may also be used such as flatbreads, whether leavened or unleavened, like lavash, pita bread, naan, chapati, injera, crepes, and the like. Other methods of cooking the food wrapper may be used such frying with oil, cooking over an open flame or cooking in an oven (for example, a tandoori oven). While a general flat food wrapper is preferred, food wrappers with 3D shape may also be used such as hard taco shells.

When cooked, the tortilla is moved to a carrier to begin the process of filing the tortilla with ingredients. The carrier may be a dish (e.g. for eat-in diners) or sheeting (e.g. for to-go diners). Metal, paper and plastic may be used separately or in combination to form the carrier. The carrier facilitates the placing of the ingredient on the tortilla, the moving the tortilla from one ingredient station to another and the serving of the burrito. In addition, the carrier may hold the tortilla in a bowl shape to better contain the ingredients or to provide walls useful in mixing the ingredients, as discussed below. For example, a dish with high sides (e.g. a soup style bowl) may be used as a carrier. Also, dishes with low side may provide sufficient height to the tortilla edges; e.g. a plate with a slightly raised lip may be suitable.

The carrier with the tortilla is usually advanced across the countertop (i.e. the cook line) between one or more ingredient stations by a preparer. At each station, one or more ingredients may be added to the tortilla at the direction of the customer. For example, a variety of meats, beans, rice, vegetables, cheese and toppings (e.g. salsa and other sauces) may be added to the tortilla. The ingredients do not need to be added in any particular order. And the ingredients may be stacked one upon another without regard to mixing. This increases the speed at which the ingredients may be added to the tortilla and thus the speed of the line.

The method also includes combining the ingredients together so that they are commingled. Through mixing of the ingredients, the customer will encounter all of the ingredients in each bite of the burrito. Without mixing, the customer is apt to encounter only one of the ingredients in each bite.

The commingling of the ingredients should not interrupt the flow of the line, meaning that it needs to take place on the line. It cannot increase the amount of wasted food or significantly increase the amount of clean up that is necessary. The commingling also cannot damage the burrito wrapper in any way, as customers will not appreciate a burrito with a torn tortilla.

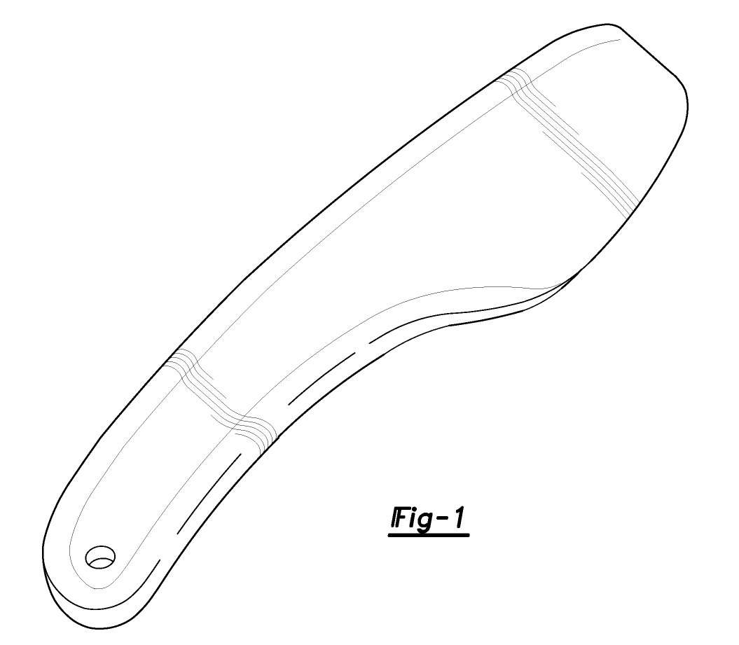

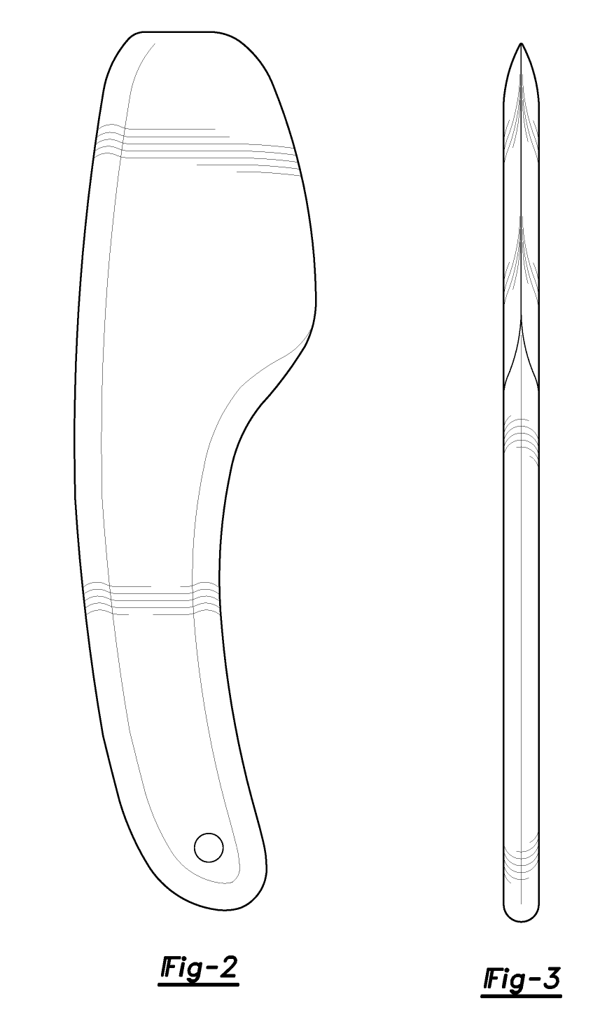

The combining of ingredients is accomplished with a spatula. An example of a preferred shape of a spatula is shown in FIGS. 1-3. The use of the spatula allows the preparer to quickly mix the ingredients without requiring the preparer to otherwise handle the ingredients. Mixing the ingredients with hands would be too messy and would be unpleasant for the customer. The spatula is easy to clean and would not appreciably influence the customer's opinion of his/her food. Further, a spatula is sufficiently inexpensive, yet durable to permit a different spatula to be used for each food item. The spatula is preferably ergonomically shaped to fit a user's hand and the head of the spatula is broad enough to enable the preparer to adequately combine the ingredients with a minimum number of folding motions. This allows the burrito to continue to move through the line to checkout without delay. Ideally, the spatula is constructed without sharp edges to help avoid tearing the tortilla during mixing. The spatula is preferably slightly malleable and has a smooth or soft textured surface to help further reduce the chance of tearing the tortilla. Use of a rigid material would increase the likelihood of tearing the tortilla and slowing food production. Preferably, the spatula is made of a food grade polymer based material, although a combination of materials may also be suitable, such as wood and silicone or a combination of polymeric materials. Polymer materials are preferred because of their combination of physical properties, relative inexpensive cost and because of the ease with which that can be reliably cleaned. While multi-use spatulas are preferred, single use utensils are also contemplated including paper or plastic coated paper utensils. Particularly preferred utensils are biodegradable and/or recyclable.

However, mere mixing with a spatula may not be enough because of the generally flat tortilla. Without walls, the chance of spilling ingredients when mixing is high. Consequently, the preparer preferably temporarily raises one edge of the tortilla to form a wall. Then the ingredients can be pushed toward and pulled away from the wall to mix the ingredients. In this manner, the ingredients are effectively combined while the chance of spilling ingredients is significantly reduced. In the alternative, the carrier may be shaped to provide support under the tortilla to create the walls, as discussed above.

Once the ingredients are commingled, the tortilla is folded and/or rolled to finish making the burrito.

While the invention is discussed in terms of tortillas and burritos, it should be understood that these techniques may be used with any food product that results from rolling a dough or bread wrapper around a set of ingredients or otherwise placing ingredients in a container made of cooked dough or bread. Other examples include wraps, flatbreads, tacos, chimachangas, dosas, crepes, etc. made with the food wrappers discussed in the application. It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method for constructing a folded food product, comprising:
on the premises of a restaurant, flattening a dough ball between heated platens to form a food wrapper;
cooking the food wrapper;
placing the cooked food wrapper in a carrier;
advancing the carrier to a station where one or more ingredients are placed on the cooked food wrapper;
commingling the ingredients on the cooked food wrapper with a spatula; and
folding and rolling the cooked food wrapper around the commingled ingredients to form a food product.

2. The method of claim 1 wherein the carrier is advanced between a plurality of stations where one or more ingredients are placed on the cooked food wrapper at each station.

3. The method of claim 1 wherein the commingling step comprises elevating one edge of the food wrapper to form a wall and mixing the ingredients with the spatula against the wall.

4. The method of claim 3 wherein the elevating of one edge of the food wrapper results from placing the cooked food wrapper into a carrier with raised walls.

5. The method of claim 3 wherein the elevating step comprises a preparer raising one edge of the food wrapper.

6. The method of claim 1 wherein the cooking step is completed in view of a customer of the restaurant.

7. The method of claim 6 wherein the food wrapper is a tortilla.

8. The method of claim 7 wherein the one or more ingredients is selected from meats, beans, rice, vegetables, cheese, toppings and combinations thereof.

9. The method of claim 8 wherein the food product is a burrito.

10. The method of claim 1 wherein the spatula is a unitary piece of plastic.

11. The method of claim 10 wherein the spatula is ergonomically shaped to fit the user's hand.

12. The method of claim 11 wherein the spatula is constructed to have slightly malleable head.

13. The method of claim 12 wherein the spatula has a smooth or soft surface.
